(19) United States
(12) Patent Application Publication
(10) Pub. No.: US 2025/0055917 A1
(43) Pub. Date: Feb. 13, 2025

(54) POLICY ENHANCEMENT FOR QUICK USER DATAGRAM PROTOCOL INTERNATIONAL CONNECTION APPLICATION

(71) Applicant: ZTE CORPORATION, Shenzhen (CN)

(72) Inventors: Zhijun LI, Shenzhen (CN); Jinguo ZHU, Shenzhen (CN); Xingyue ZHOU, Shenzhen (CN)

(73) Assignee: ZTE CORPORATION, Shenzhen (CN)

(21) Appl. No.: 18/930,592

(22) Filed: Oct. 29, 2024

Related U.S. Application Data
(63) Continuation of application No. PCT/CN2022/110690, filed on Aug. 5, 2022.

(51) Int. Cl. H04L 67/14; H04L 47/193

(52) U.S. Cl. CPC H04L 67/14; H04L 47/193

(57) ABSTRACT

A wireless communication method for use in a session management function is disclosed. The method comprises transmitting, to a user plane function, a Quick User Datagram Protocol Internet Connections (QUIC) traffic instruction, and receiving, from the user plane function, at least one QUIC report associated with QUIC traffic, wherein the QUIC traffic instruction comprises at least one of a QUIC event report instruction indicating at least one event associated with the at least one QUIC report or a QUIC statistic report instruction indicating at least one statistic included in each QUIC report.

### CROSS-REFERENCE TO RELATED APPLICATION

This application claims the benefit of priority under 35 U.S.C. § 120 as a continuation of International Patent Application No. PCT/CN2022/110690, filed on Aug. 5, 2022, the disclosure of which is incorporated herein by reference in its entirety.

### TECHNICAL FIELD

This document is directed generally to wireless communications, and in particular to QUIC (Quick User Datagram Protocol (UDP) International Connection) communications.

### BACKGROUND

In recent years, the QUIC protocol is rapidly developing for setting up an international connection between two end points. It is regarded as the next generation protocol used for HTTP (Hypertext Transfer Protocol). That is the QUIC protocol may be used to replace the existing TCP (transmission Control Protocol)+TLS (Transport Layer Security)+HTTP protocol.

### SUMMARY

One QUIC connection is a secured connection between two endpoints (e.g., between a UE (user equipment) and an Application Server of the UE) which disables a transmission node in the network to inspect contents transmitted in the QUIC connection.

Currently, the 5G packet detection and forwarding model only can detect a QUIC traffic from other TCP/UDP traffic. It is difficult for the network to recognize which service or application to which the QUIC traffic is related. Thus, it may be impossible to generate an appropriate policy applied to the corresponding QUIC traffic.

In addition, as current QoS flow control normally provides a fixed AMBR (Average Maximum Bit Rate) value and a fixed GBR (Guaranteed Bit Rate) value for a QoS (Quality-of-Service) flow, a flexible QoS requirement may not be possible for the QUIC traffic transmission because the QUIC data transmission is encrypted and the inner payload inside QUIC packets may have drastically different QoS requirements.

This document relates to methods, systems, and devices for QUIC communications, and in particular to methods, systems, and devices associated with policy for QUIC applications. The present disclosure relates to a wireless communication method for use in a session management function. The method comprises:
transmitting, to a user plane function, a Quick User Datagram Protocol Internet Connections, QUIC, traffic instruction, and
receiving, from the user plane function, at least one QUIC report associated with QUIC traffic,
wherein the QUIC traffic instruction comprises at least one of a QUIC event report instruction indicating at least one event associated with the at least one QUIC report or a QUIC statistic report instruction indicating at least one statistic included in each QUIC report.

Various embodiments may preferably implement the following features:

Preferably or in some embodiments, the at least one event associated with the at least one QUIC report comprises at least one of:
an event associated with a QUIC traffic detection,
an event associated with a QUIC connection establishment,
an event associated with a QUIC connection release,
an event associated with a start of a QUIC data block transmission, or
an event associated with an end of a QUIC data block transmission.

Preferably or in some embodiments, the at least one statistic included in each QUIC report comprises at least one of:
an average delay of QUIC traffic transmissions,
a maximum delay of QUIC traffic transmissions,
a minimum delay of QUIC traffic transmissions,
an average size of QUIC data blocks,
a maximum size of QUIC data blocks,
a minimum size of QUIC data blocks, an average interval between every two consecutive QUIC traffic transmissions, or
an analytic duration indicating a period in which QUIC traffic characteristics used for determining each QUIC report are collected.

Preferably, each QUIC report comprises at least one of:
at least one QUIC traffic parameter of the QUIC traffic,
the at least one QUIC report event associated with the QUIC report, or
the at least one statistic of the QUIC traffic associated with the QUIC report.

Preferably, the at least one QUIC traffic parameter comprises at least one of:
a QUIC protocol indication associated with the QUIC traffic,
an internet protocol, IP, address of a wireless terminal associated with the QUIC traffic and a User Datagram Protocol, UDP, port associated with the wireless terminal,
an IP address of a remote server associated with the QUIC traffic and a UDP port associated with the remote server,
at least one QUIC connection identifier of the QUIC traffic,
a QUIC version of the QUIC traffic, or
a packet number of the QUIC traffic.

The present disclosure relates to a wireless communication method for use in a user plane function. The method comprises:
receiving, from a session management function, a Quick User Datagram Protocol Internet Connections, QUIC, traffic instruction, and
transmitting, to the session management function, at least one QUIC report associated with QUIC traffic,
wherein the QUIC traffic instruction comprises at least one of a QUIC event report instruction indicating at least one event associated with the at least one QUIC report or a QUIC statistic report instruction indicating at least one statistic included in each QUIC report.

Various embodiments may preferably implement the following features:

Preferably or in some embodiments, the at least one event associated with the at least one QUIC report comprises at least one of:
an event associated with a QUIC traffic detection,
an event associated with a QUIC connection establishment,
an event associated with a QUIC connection release,
an event associated with a start of a QUIC data block transmission, or
an event associated with an end of a QUIC data block transmission.

Preferably or in some embodiments, the at least one statistic included in each QUIC report comprises at least one of:
an average delay of QUIC traffic transmissions,
a maximum delay of QUIC traffic transmissions,
a minimum delay of QUIC traffic transmissions,
an average size of QUIC data blocks,
a maximum size of QUIC data blocks,
a minimum size of QUIC data blocks, an average interval between every two consecutive QUIC traffic transmissions, or
an analytic duration indicating a period in which QUIC traffic characteristics used for determining each QUIC report are collected.

Preferably or in some embodiments, each QUIC report comprises at least one of:
at least one QUIC traffic parameter of the QUIC traffic,
the at least one QUIC report event associated with the QUIC report, or
the at least one statistic of the QUIC traffic associated with the QUIC report.

Preferably or in some embodiments, the at least one QUIC traffic parameter comprises at least one of:
a QUIC protocol indication associated with the QUIC traffic,
an internet protocol, IP, address of a wireless terminal associated with the QUIC traffic and a User Datagram Protocol, UDP, port associated with the wireless terminal,
an IP address of a remote server associated with the QUIC traffic and a UDP port associated with the remote server,
at least one QUIC connection identifier of the QUIC traffic,
a QUIC version of the QUIC traffic, or
a packet number of the QUIC traffic.

The present disclosure relates to a wireless communication method for use in a session management function. The method comprising:
transmitting, to a policy control function, information of Quick User Datagram Protocol Internet Connections, QUIC, traffic, and
receiving, from the policy control function, policy and charging control, PCC, rules determined based on the information of the QUIC traffic for a QUIC application,
wherein the QUIC information comprises at least one event associated with the information of the QUIC traffic and/or statistics of the QUIC traffic.

Various embodiments may preferably implement the following features:

Preferably or in some embodiments, the at least one event associated with the at least one QUIC report comprises at least one of:
an event associated with a QUIC traffic detection,
an event associated with a QUIC connection establishment,
an event associated with a QUIC connection release,
an event associated with a start of a QUIC data block transmission, or
an event associated with an end of a QUIC data block transmission.

Preferably or in some embodiments, the at least one statistic included in each QUIC report comprises at least one of:
an average delay of QUIC traffic transmissions,
a maximum delay of QUIC traffic transmissions,
a minimum delay of QUIC traffic transmissions,
an average size of QUIC data blocks,
a maximum size of QUIC data blocks,
a minimum size of QUIC data blocks, an average interval between every two consecutive QUIC traffic transmissions, or
an analytic duration indicating a period in which QUIC traffic characteristics used for determining each QUIC report are collected.

Preferably or in some embodiments, the information of the QUIC traffic further comprises at least one QUIC traffic parameter comprising at least one of:
a QUIC protocol indication associated with the QUIC traffic,
an internet protocol, IP, address of a wireless terminal associated with the QUIC traffic and a User Datagram Protocol, UDP, port associated with the wireless terminal,
an IP address of a remote server associated with the QUIC traffic and a UDP port associated with the remote server,
at least one QUIC connection identifier of the QUIC traffic,
a QUIC version of the QUIC traffic, or
a packet number of the QUIC traffic.

Preferably or in some embodiments, the PCC rules comprise at least one of:
QUIC application information,
QUIC connection information, or
at least one QUIC flow parameter.

Preferably or in some embodiments, the QUIC application information comprises at least one of:
an application identifier of the QUIC application,
an application service type of the QUIC application, or
an identifier of a wireless terminal associated with the QUIC application.

Preferably or in some embodiments, the QUIC connection information comprises at least one of:
at least one QUIC Connection identifier of the QUIC application,
an internet protocol, IP, address of a wireless terminal associated with the QUIC application and a UDP port associated with the wireless terminal, or
an IP address of a remote server associated with the QUIC application and a UDP port associated with the remote server. Preferably or in some embodiments, the at least one QUIC flow parameters comprises at least one of:
a quality of service, QoS, Flow Identifier,
an Allocation and Retention Priority,
an Average Maximum Bit Rate, AMBR, or
a Guaranteed Bit Rate, GBR.

Preferably or in some embodiments, the at least one QUIC flow parameters comprises at least one of:
a highest AMBR,
a lowest AMBR,
a highest GBR, or
a lowest GBR.

Preferably or in some embodiments, the at least one QUIC flow parameters comprises at least one of:
a list of QUIC Packet Number ranges and AMBRs corresponding to the QUIC Packet Number ranges, or
a list of QUIC Packet Number ranges and GBRs corresponding to the QUIC Packet Number ranges.

The present disclosure relates to a wireless communication method for use in a policy control function. The method comprises:
receiving, from a session management function, information of Quick User Datagram Protocol Internet Connections, QUIC, traffic, and
transmitting, to the session management function, policy and charging control, PCC, rules determined based on the information of the QUIC traffic for a QUIC application,
wherein the QUIC information comprises at least one event associated with the information of the QUIC traffic and/or statistics of the QUIC traffic.

Various embodiments may preferably implement the following features:

Preferably or in some embodiments, the at least one event associated with the at least one QUIC report comprises at least one of:
an event associated with a QUIC traffic detection,
an event associated with a QUIC connection establishment,
an event associated with a QUIC connection release,
an event associated with a start of a QUIC data block transmission, or
an event associated with an end of a QUIC data block transmission.

Preferably or in some embodiments, the at least one statistic included in each QUIC report comprises at least one of:
an average delay of QUIC traffic transmissions,
a maximum delay of QUIC traffic transmissions,
a minimum delay of QUIC traffic transmissions,
an average size of QUIC data blocks,
a maximum size of QUIC data blocks,
a minimum size of QUIC data blocks, an average interval between every two consecutive QUIC traffic transmissions, or
an analytic duration indicating a period in which QUIC traffic characteristics used for determining each QUIC report are collected.

Preferably or in some embodiments, the information of the QUIC traffic further comprises at least one QUIC traffic parameter comprising at least one of:
a QUIC protocol indication associated with the QUIC traffic,
an internet protocol, IP, address of a wireless terminal associated with the QUIC traffic and a User Datagram Protocol, UDP, port associated with the wireless terminal,
an IP address of a remote server associated with the QUIC traffic and a UDP port associated with the remote server,
at least one QUIC connection identifier of the QUIC traffic,
a QUIC version of the QUIC traffic, or
a packet number of the QUIC traffic.

Preferably or in some embodiments, the PCC rules comprise at least one of:
QUIC application information,
QUIC connection information, or
at least one QUIC flow parameter.

Preferably or in some embodiments, the QUIC application information comprises at least one of:
an application identifier of the QUIC application,
an application service type of the QUIC application, or
an identifier of a wireless terminal associated with the QUIC application.

Preferably or in some embodiments, the QUIC connection information comprises at least one of:
at least one QUIC Connection identifier of the QUIC application,
an internet protocol, IP, address of a wireless terminal associated with the QUIC application and a UDP port associated with the wireless terminal, or
an IP address of a remote server associated with the QUIC application and a UDP port associated with the remote server.

Preferably or in some embodiments, the at least one QUIC flow parameters comprises at least one of:
a quality of service, QoS, Flow Identifier,
an Allocation and Retention Priority,
an Average Maximum Bit Rate, AMBR, or
a Guaranteed Bit Rate, GBR.

Preferably or in some embodiments, the at least one QUIC flow parameters comprises at least one of:
a highest AMBR,
a lowest AMBR,
a highest GBR, or
a lowest GBR.

Preferably or in some embodiments, the at least one QUIC flow parameters comprises at least one of:
a list of QUIC Packet Number ranges and AMBRs corresponding to the QUIC Packet Number ranges, or
a list of QUIC Packet Number ranges and GBRs corresponding to the QUIC Packet Number ranges.

Preferably or in some embodiments, the wireless communication method further comprises:
transmitting, to a network data analysis function, a QUIC assistance request including the information of the QUIC traffic, and
receiving, from the network data analysis function, QUIC assistance information associated with the QUIC traffic,
wherein the PCC rules are determined based on the QUIC assistance information.

Preferably or in some embodiments, the QUIC assistance information comprises at least one of:
an application service type associated with the QUIC traffic,
an application identifier associated with the QUIC traffic,
at least one QoS policy for the QUIC traffic, or
at least one QUIC packet number range corresponding to the at least one QoS policy.

Preferably or in some embodiments, the wireless communication method further comprises:
transmitting, to an application function, a policy authorization notification including the information of the QUIC traffic, and
receiving, from the application function, application service information associated with the QUIC traffic, wherein the PCC rules are determined based on the application service information.

Preferably or in some embodiments, the application service information comprising at least one of:
an application service type associated with the QUIC traffic,
an application identifier associated with the QUIC traffic,
an identifier of a wireless terminal associated with the QUIC traffic,
an internet protocol, IP, address of a wireless terminal associated with the QUIC traffic and a User Datagram Protocol, UDP, port associated with the wireless terminal,
an IP address of a remote server associated with the QUIC traffic and a UDP port associated with the remote server, or
at least one QoS policy for the QUIC traffic.

The present disclosure relates to a wireless communication method for use in a network data analysis function, the method comprising:
receiving, from a policy control function, a Quick User Datagram Protocol Internet Connections, QUIC, assistance request including information of QUIC traffic, and
transmitting, to the policy control function, QUIC assistance information associated with the QUIC traffic,
wherein the QUIC information comprises at least one event associated with the information of the QUIC traffic and/or statistics of the QUIC traffic.

Various embodiments may preferably implement the following features:

Preferably or in some embodiments, the at least one event associated with the at least one QUIC report comprises at least one of:
an event associated with a QUIC traffic detection,
an event associated with a QUIC connection establishment,
an event associated with a QUIC connection release,
an event associated with a start of a QUIC data block transmission, or
an event associated with an end of a QUIC data block transmission.

Preferably or in some embodiments, the at least one statistic included in each QUIC report comprises at least one of:
an average delay of QUIC traffic transmissions,
a maximum delay of QUIC traffic transmissions,
a minimum delay of QUIC traffic transmissions,
an average size of QUIC data blocks,
a maximum size of QUIC data blocks,
a minimum size of QUIC data blocks, an average interval between every two consecutive QUIC traffic transmissions, or
an analytic duration indicating a period in which QUIC traffic characteristics used for determining each QUIC report are collected.

Preferably or in some embodiments, the information of the QUIC traffic further comprises at least one QUIC traffic parameter comprising at least one of:
a QUIC protocol indication associated with the QUIC traffic,
an internet protocol, IP, address of a wireless terminal associated with the QUIC traffic and a User Datagram Protocol, UDP, port associated with the wireless terminal,
an IP address of a remote server associated with the QUIC traffic and a UDP port associated with the remote server,
at least one QUIC connection identifier of the QUIC traffic,
a QUIC version of the QUIC traffic, or
a packet number of the QUIC traffic.

Preferably or in some embodiments, the QUIC assistance information comprises at least one of:
an application service type associated with the QUIC traffic,
an application identifier associated with the QUIC traffic,
at least one QoS policy for the QUIC traffic, or
at least one QUIC packet number range corresponding to the at least one QoS policy.

The present disclosure relates to a wireless communication method for use in an application function. The method comprises:
receiving, from a policy control function, a policy authorization notification including information of Quick User Datagram Protocol Internet Connections, QUIC, traffic, and
transmitting, to the policy control function, application service information associated with the QUIC traffic,
wherein the QUIC information comprises at least one event associated with the information of the QUIC traffic and/or statistics of the QUIC traffic.

Various embodiments may preferably implement the following features:

Preferably or in some embodiments, the at least one event associated with the at least one QUIC report comprises at least one of:
an event associated with a QUIC traffic detection,
an event associated with a QUIC connection establishment,
an event associated with a QUIC connection release,
an event associated with a start of a QUIC data block transmission, or
an event associated with an end of a QUIC data block transmission.

Preferably or in some embodiments, the at least one statistic included in each QUIC report comprises at least one of:
an average delay of QUIC traffic transmissions,
a maximum delay of QUIC traffic transmissions,
a minimum delay of QUIC traffic transmissions,
an average size of QUIC data blocks,
a maximum size of QUIC data blocks,
a minimum size of QUIC data blocks, an average interval between every two consecutive QUIC traffic transmissions, or
an analytic duration indicating a period in which QUIC traffic characteristics used for determining each QUIC report are collected.

Preferably or in some embodiments, the information of the QUIC traffic further comprises at least one QUIC traffic parameter comprising at least one of:
a QUIC protocol indication associated with the QUIC traffic,
an internet protocol, IP, address of a wireless terminal associated with the QUIC traffic and a User Datagram Protocol, UDP, port associated with the wireless terminal,
an IP address of a remote server associated with the QUIC traffic and a UDP port associated with the remote server,
at least one QUIC connection identifier of the QUIC traffic,
a QUIC version of the QUIC traffic, or
a packet number of the QUIC traffic.

Preferably or in some embodiments, the application service information comprising at least one of:
an application service type associated with the QUIC traffic,
an application identifier associated with the QUIC traffic,
an identifier of a wireless terminal associated with the QUIC traffic,
an internet protocol, IP, address of a wireless terminal associated with the QUIC traffic and a User Datagram Protocol, UDP, port associated with the wireless terminal,
an IP address of a remote server associated with the QUIC traffic and a UDP port associated with the remote server, or
at least one QoS policy for the QUIC traffic.

The present disclosure relates to a session management node. The session management node comprises:
a communication unit, configured to:
transmit, to a user plane function, a Quick User Datagram Protocol Internet Connections, QUIC, traffic instruction, and
receive, from the user plane function, at least one QUIC report associated with QUIC traffic,
wherein the QUIC traffic instruction comprises at least one of a QUIC event report instruction indicating at least one event associated with the at least one QUIC report or a QUIC statistic report instruction indicating at least one statistic included in each QUIC report.

Various embodiments may preferably implement the following feature:

Preferably or in some embodiments, the session management node further comprises a processor configured to perform any of aforementioned wireless communication methods.

The present disclosure relates to a user plane node. The user plane node comprises:
a communication unit, configured to:
receive, from a session management function, a Quick User Datagram Protocol Internet Connections, QUIC, traffic instruction, and
transmit, to the session management function, at least one QUIC report associated with QUIC traffic,
wherein the QUIC traffic instruction comprises at least one of a QUIC event report instruction indicating at least one event associated with the at least one QUIC report or a QUIC statistic report instruction indicating at least one statistic included in each QUIC report.

Various embodiments may preferably implement the following feature:

Preferably or in some embodiments, the user plane node further comprises a processor configured to perform any of the aforementioned wireless communication methods.

The present disclosure relates to a session management node. The session management node comprises:
a communication unit, configured to:
transmit, to a policy control function, information of Quick User Datagram Protocol Internet Connections, QUIC, traffic, and
receive, from the policy control function, policy and charging control, PCC, rules determined based on the information of the QUIC traffic for a QUIC application,
wherein the QUIC information comprises at least one event associated with the information of the QUIC traffic and/or statistics of the QUIC traffic.

Various embodiments may preferably implement the following feature:

Preferably or in some embodiments, the session management node further comprises a processor configured to perform any of aforementioned wireless communication methods.

The present disclosure relates to a policy control node. The policy control node comprises:
a communication unit, configured to:
receive, from a session management function, information of Quick User Datagram Protocol Internet Connections, QUIC, traffic, and
transmit, to the session management function, policy and charging control, PCC, rules determined based on the information of the QUIC traffic for a QUIC application,
wherein the QUIC information comprises at least one event associated with the information of the QUIC traffic and/or statistics of the QUIC traffic.

Various embodiments may preferably implement the following feature:

Preferably or in some embodiments, the policy control node further comprises a processor configured to perform any of aforementioned wireless communication methods.

The present disclosure relates to a network data analysis node. The network data analysis node comprises:
a communication unit, configured to:
receive, from a policy control function, a Quick User Datagram Protocol Internet Connections, QUIC, assistance request including information of QUIC traffic, and
transmit, to the policy control function, QUIC assistance information associated with the QUIC traffic,
wherein the QUIC information comprises at least one event associated with the information of the QUIC traffic and/or statistics of the QUIC traffic.

Various embodiments may preferably implement the following feature:

Preferably or in some embodiments, the network data analysis node further comprises a processor configured to perform any of aforementioned wireless communication methods.

The present disclosure relates to an application node. The application node comprises: a communication unit, configured to:
receive, from a policy control function, a policy authorization notification including information of Quick User Datagram Protocol Internet Connections, QUIC, traffic, and
transmit, to the policy control function, application service information associated with the QUIC traffic,
wherein the QUIC information comprises at least one event associated with the information of the QUIC traffic and/or statistics of the QUIC traffic.

Various embodiments may preferably implement the following feature:

Preferably or in some embodiments, the application node further comprises a processor configured to perform any of aforementioned wireless communication methods.

The present disclosure relates to a computer program product comprising a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 shows a schematic diagram of a network (architecture) according to an embodiment of the present disclosure.

FIG. 2 shows a schematic diagram of a PDU Session Establishment procedure according to an embodiment of the present disclosure.

FIG. 3 shows a schematic diagram of a PFCP Session Establishment according to an embodiment of the present disclosure.

FIG. 4 shows a schematic diagram of a PDU Session Modification procedure according to an embodiment of the present disclosure.

FIG. 5 shows a schematic diagram of a QUIC traffic handling procedure according to an embodiment of the present disclosure.

FIG. 6 shows a schematic diagram of retrieving policy and charging control rules for QUIC application according to an embodiment of the present disclosure.

FIG. 7 shows an example of a schematic diagram of a wireless terminal according to an embodiment of the present disclosure.

FIG. 8 shows an example of a schematic diagram of a wireless network node according to an embodiment of the present disclosure.

FIGS. 9 to 14 show flowcharts of methods according to embodiments of the present disclosure.

### DETAILED DESCRIPTION

In order to make it possible to enable the network to correctly make policy rules for QUIC application, the present disclosure discloses a method of enhancing the UPF to report QUIC traffic characteristics associated with QUIC traffic detection. As a result, the network may be able to recognize the service and/or application to which the QUIC traffic is related and accordingly determine accurate policy rules for handling the QUIC traffic.

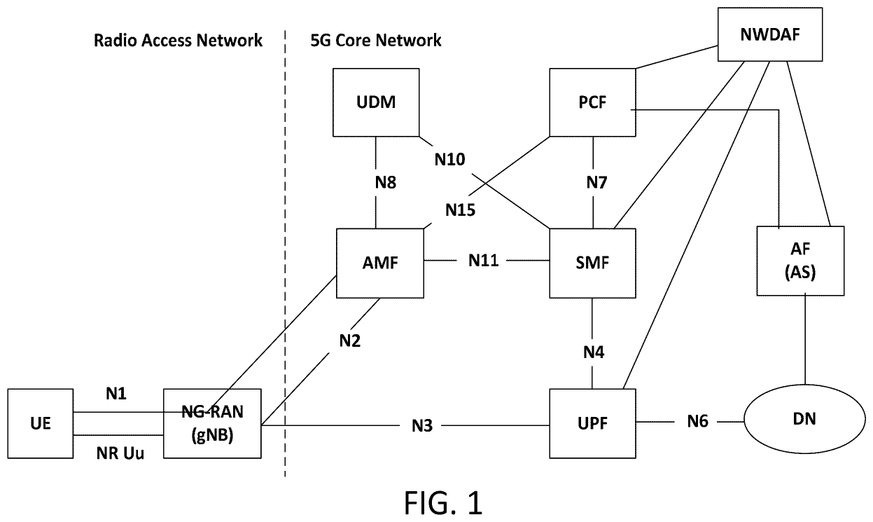

FIG. 1 shows a schematic diagram of a 5G network (architecture) according to an embodiment of the present disclosure. The network shown in FIG. 1 comprises the following network entities or network functions (NFs):
1. UE (User Equipment):
The UE refers to a mobile terminal accessing to the 5G network.
2. NG RAN (Next Generation Radio Access Network):
In the 5G network, the NG RAN is a new radio (NR) base station and is also named as gNB. In addition, the NG RAN may be equal to RAN (node) in the present disclosure.
3. AMF (Access and Mobility Management function):
The AMF provides access management and mobility management for the UE. For example, the AMF may provide registration to network, registration during UE mobility, etc.
4. SMF (Session Management Function):
The SMF provides PDU session management for the UE, e.g., IP address allocation, QoS flow setup, etc.
5. UPF (User plane function)
The UPF provides IP traffic routing and forwarding management.
6. PCF (Policy Control Function)
The PCF provides QoS policy rules to control plane (network) functions to enforce the rules.
7. AF (Application Function):
The AF provides instructions to the PCF, to influence the QoS policy rules.
8. NWDAF (Network Data Analytics Function):
The NWDAF collects network events from other NF(s) (e.g., AMF, SMF, PCF, UPF, etc.) and analyzes network behavior and status, e.g., by using artificial intelligence and/or machine learning.

In the 5G network, data traffic transmissions are controlled by the SMF and the UPF. The SMF, control plane function (CP Function) for data traffic controlling, handles signalling aspects of the data traffic transmissions (e.g., PDU session establishment/modification/release, N4 session establishment/modification/release, N4 rules generation, etc.). The UPF, user plane function (UP Function) for data traffic controlling, handles user plane aspects of the data traffic transmission (e.g., traffic detection, traffic filtering, and traffic forwarding, usage reporting, etc.), based on instruction(s) (e.g. N4 rules) received from the SMF.

After the UE registers to the 5G network, if communications with an Application Server are needed, the UE requests a PDU Session Establishment procedure towards the 5G network. During the PDU Session Establishment procedure, the 5G network assigns a default QoS flow for the UE and may additionally assign indicated QoS flow(s) for the UE according to the UE request or according to instructions from the policy configured for the UE.

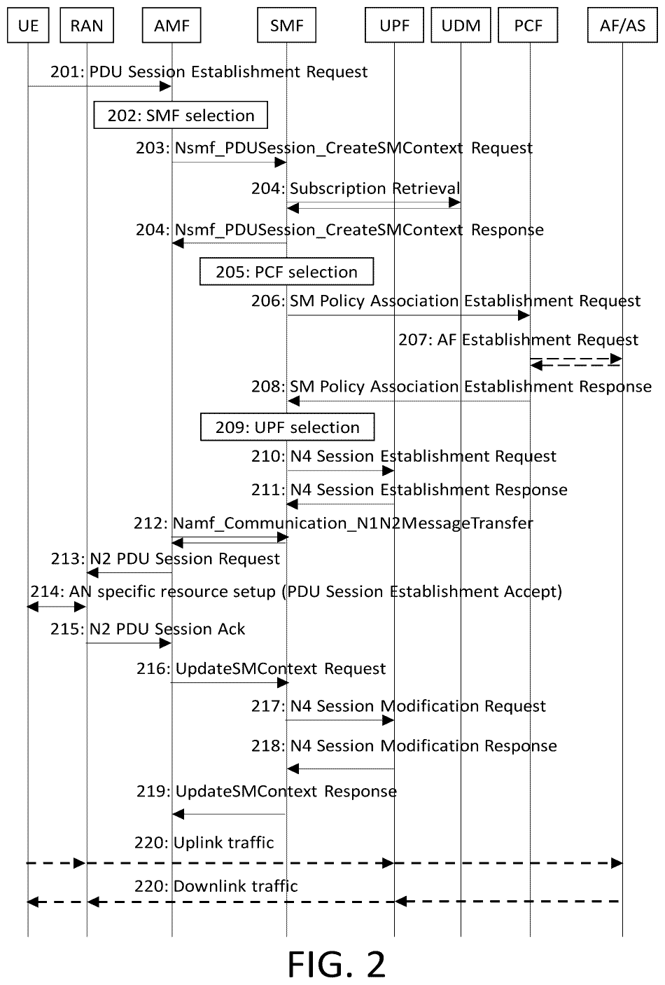

FIG. 2 shows a schematic diagram of a PDU Session Establishment procedure according to an embodiment of the present disclosure. In FIG. 2, the SMF assigns a set of QoS flow(s) to guarantee the communications between the UE and the Application Server.

Specifically, after UE registers to the 5G network, the UE can request the PDU session establishment procedure comprising the following steps:

Step 201: UE to AMF: NAS Message (S-NSSAI(s), UE Requested DNN, PDU Session ID, Request type, N1 SM container (PDU Session Establishment Request)).

The PDU Session Establishment Request is included in the NAS message and encapsulated in the N1 SM container. The NAS message sent by the UE is encapsulated by the RAN in a N2 message towards the AMF.

Step 202: The AMF selects a proper SMF (i.e., anchor SMF) to serve the PDU session, based on the requested DNN, S-NSSAI, and the current UE location information.

Step 203: AMF to SMF: Nsmf_PDUSession_CreateSMContext Request (SUPI, selected DNN, UE requested DNN, S-NSSAI(s), PDU Session ID, AMF ID, Request Type, N1 SM container (PDU Session Establishment Request), User location information, Access Type, RAT Type, PEI, GPSI).

The SUPI (Subscription Permanent Identifier) uniquely identifies the UE subscription. The AMF ID carries the GUAMI (Globally Unique AMF ID) uniquely identifying the AMF serving the UE.

Step 204: SMF to AMF: Nsmf_PDUSession_CreateSMContext Response (Cause, SM Context ID). The SM Context ID identifies the SM context created in the SMF for the UE.

Step 205: If a dynamic PCC (policy and charging control) is to be used for the PDU Session, the SMF selects a proper PCF to server the PDU session.

Step 206: The SMF sends a Npcf_PolicyAssociation_Create Request to the PCF, to perform an SM Policy Association Establishment procedure and get the default PCC Rules for the PDU Session. Necessary parameters such as SUPI, PDU Session ID, DNN, S-NSSAI shall be provided in the request. Other parameters such as GPSI, UE IP address, UE External ID, RAT Type, Access Type, may also be provided in the request message.

Step 207: For a specific service, the PCF may interact with the AF to establish AF association, for a specific service. The AF association establishment allows the AF to dynamically influence the traffic model of the PDU session via the PCF, e.g., to setup new dedicated QoS flow, or modify the existing QoS flow.

Step 208: The PCF sends Npcf_PolicyAssociation_Create Response to the SMF, to return the default PCC Rules for the PDU Session.

Step 209: The SMF selects an UPF acting as PDU Session Anchor (PSA).

Step 210: The SMF sends an N4 Session Establishment Request to the UPF to request establish N4 session for this PDU Session, carrying a set of N4 rules for packet detection and QoS enhancement to be installed in the UPF. The N4 rules include Packet Detection Rule (PDR), Forward Action Rule (FAR), QOS Enhancement Rule (QER), Usage Reporting Rule (URR), etc.

If the SMF receives PCC rules from the PCF, the SMF maps the PCC rules to a set of QoS flows and generates a set of N4 rules (e.g., PDR/FAR/QER/URR rules) accordingly to reflect the determined QoS flows.

The UPF installs these N4 rules for this PDU session and uses these rules to filter the uplink/downlink traffic and performs corresponding QoS enhancement to the filtered uplink/downlink traffic.

Step 211: The UPF acknowledges by sending an N4 Session Establishment Response.

Step 212: SMF to AMF: Namf_Communication_NIN2MessageTransfer Request (PDU Session ID, N2 SM information (PDU Session ID, QFI(s), QoS Profile(s), N3 CN Tunnel Info), N1 SM container (PDU Session Establishment Accept)).

The N2 SM information carries information that the AMF shall forward to the RAN, including the N3 CN Tunnel Info carrying I-UPF UL F-TEID, the QFIs and QoS profiles used by the RAN to setup QoS flows.

One or multiple QoS profiles and the corresponding QFIs are be provided to the RAN, to allow the RAN to control the QoS flow and perform traffic detection and admission control at QoS flow level.

A typical QoS profile has the following parameters:
QFI, used to uniquely identify one QoS flow in a PDU session;
ARP, which indicates the Allocation and Retention Priority of the QoS flow;
GBR QOS flow parameters, used by the RAN to control the QoS flow, such as Maximum Flow Bit Rate Downlink, Maximum Flow Bit Rate Uplink, Guaranteed Flow Bit Rate Downlink, Guaranteed Flow Bit Rate Uplink, Maximum Packet Loss Rate Downlink, Maximum Packet Loss Rate Uplink, etc.

The N1 SM container contains the PDU Session Establishment Accept that the AMF shall provide to the UE. Within the PDU Session Establishment Accept, the following parameters are included: PDU session ID, PDU session type, UE IP address, one or multiple Qos rules, QoS Flow level QoS parameters associated to those QoS rule(s), DNN, S-NSSAI, etc.

Step 213: AMF to RAN: N2 PDU Session Request (N2 SM information, NAS message (PDU Session ID, N1 SM container (PDU Session Establishment Accept))). The AMF sends the NAS message containing PDU Session ID and PDU Session Establishment Accept targeted to the UE and the N2 SM information received from the SMF within the N2 PDU Session Request to the RAN.

Step 214: RAN to UE: The RAN may issue AN specific signalling exchange with the UE that is related with the information received from SMF. For example, in case of a 3GPP RAN, an RRC Connection Reconfiguration may take place with the UE establishing the necessary RAN resources related to the QoS Rules for the PDU Session request. RAN forwards the NAS message (PDU Session ID, N1 SM container (PDU Session Establishment Accept)) to the UE. RAN also allocates AN N3 tunnel information for the PDU Session.

Step 215: RAN to AMF: N2 PDU Session Response (PDU Session ID, Cause, N2 SM information (PDU Session ID, AN Tunnel Info, List of accepted/rejected QFI(s))).

The AN Tunnel Info corresponds to the Access Network address of the N3 tunnel corresponding to the PDU Session.

Step 216: AMF to SMF: Nsmf_PDUSession_UpdateSMContext Request (N2 SM information).

The AMF forwards the N2 SM information received from RAN to the SMF. If the list of rejected QFI(s) is included in N2 SM information, the SMF shall release the rejected QFI(s) associated QoS profiles.

Step 217: The SMF sends an N4 Session Modification request to the UPF. The SMF provides RAN Tunnel Info to the UPF, and possibly together with the updated N4 rules.

Step 218: The UPF updates the RAN Tunnel Info and installs the N4 rules. The UPF sends N4 Session Modification response to the SMF.

Step 219: The SMF sends a Nsmf_PDUSession_UpdateSMContext Response to the AMF.

Step 220: The UE initiates uplink traffic transmission, e.g., towards its Application Server or receives downlink traffic, e.g., from its Application Server.

During the PDU Session Establishment procedure, the SMF may allocate the default QoS flow to the UE for the PDU session. The SMF may also allocate the dedicated QoS flows for this PDU session, if the SMF is instructed by the locally configured PCC rules (e.g., associated with the DNN and S-NSSAI) or instructed by the dynamic PCC rules from the PCF.

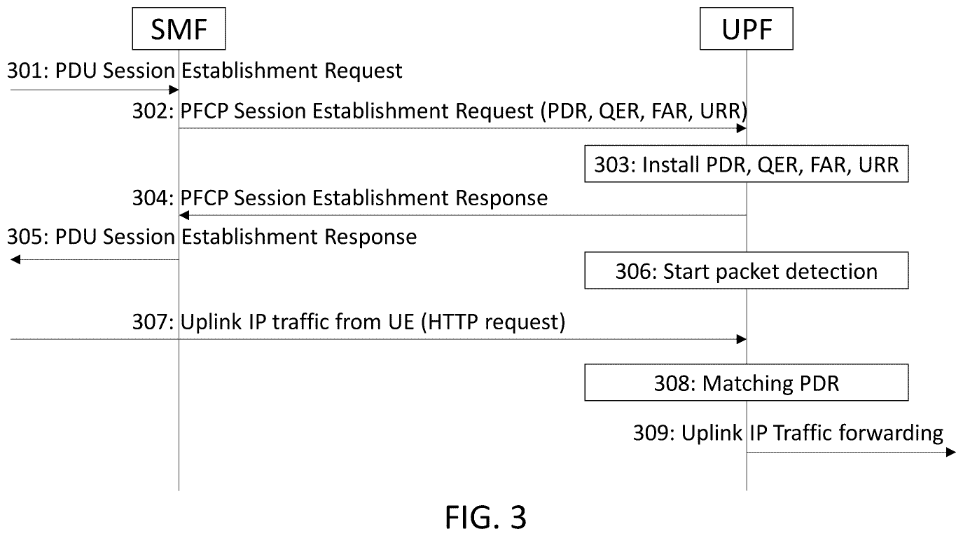

To detail the procedure between the SMF and the UPF during the PDU Session Establishment (i.e., step 210-211 in FIG. 2), FIG. 3 shows a PFCP Session Establishment procedure between the SMF and UPF to setup the N4 session according to an embodiment of the present disclosure.

More specifically, during the PFCP Session Establishment/Modification procedure, the SMF provides necessary information to the UPF, to instruct the UPF to perform packet detection and forwarding.

Step 301: The SMF is triggered to establishment PFCP session to the UP Function. The trigger is the PDU session establishment request message from the AMF.

The SMF selects proper UP Function, based on DNN, S-NSSAI and other necessary information.

Step 302: The SMF sends a PFCP Session Establishment Request to the selected UP Function, carrying the PDR, QER, FAR, and URR:

The PDR (Packet Detecting Rule) defines the packet filters for service data flows, e.g., to filter out the uplink/downlink traffic from/to a specific application (e.g., HTTP message to a specific website).

In the PDR, one or more SDF (Service Data Flow) Filter may be present to express the packet filter for specific service data flow.

The QER (QOS Enforcement Rule) which is associated to at least one PDR defines how to control the QoS of the detected service flow.

The FAR (Forwarding Action Rule) which is associated to at least one PDR defines how to route and forward the detected service flow. For example, MEC traffic may be required to route to local servers.

The URR (Usage Reporting Rule) which is associated to at least one PDR defines how to report the volume/time usage of the detected service flow, and how to report the usage to the CP Function.

Step 303: On receiving the PFCP Session Establishment request from the SMF, the UPF installs the received rules (i.e., PDR/QER/FAR/URR) for this PFCP session.

Step 304: The UPF sends back a PFCP Session Establishment Response message to the SMF.

Step 305: The SMF responds to the trigger entity (e.g., AMF) of the PDU session establishment, by sending PDU Session Establishment Response message.

Step 306: The UPF starts to detect the uplink/downlink traffic from/to the UE and tries to match the receiving IP packets with the PDR(s). If incoming IP packets matches one PDR, the corresponding QER/URR/FAR shall be performed.

Step 307: Later on, the UE initiates uplink traffic towards the server. For example, the UE sends an HTTP request to the dedicated Web Server.

Step 308: The UPF inspects the uplink traffic from the UE and detects whether it matches one of the installed PDRs. For example, the uplink traffic (HTTP request from the UE) matches the PDR targeting to detect the HTTP request from the UE.

For certain IP traffic (e.g., HTTP traffic), special actions might be required before the UPF forwarding the IP traffic. For example, an HTTP header enrichment might be required by the SMF.

Step 309: As per the instruction of the FAR rule, the UPF sends the IP packets onwards. The IP packets might be altered by the UPF based on the instruction from the SMF, e.g., the HTTP header enrichment might be performed to HTTP traffic.

In subsequent procedures, on the demand of application traffic transmission, a PDU Session Modification procedure may be initiated by the UE or the PCF to request the SMF to allocate dedicated QoS flows. The SMF retrieves updated PCC rules from the PCF and allocates dedicated QoS flows accordingly. Consequently, the SMF sends N2 SM information to the RAN to update the QFIs and QoS profiles stored in the RAN and sends N1 SM Container to the UE to update the QoS flows and QoS rules stored in the UE.

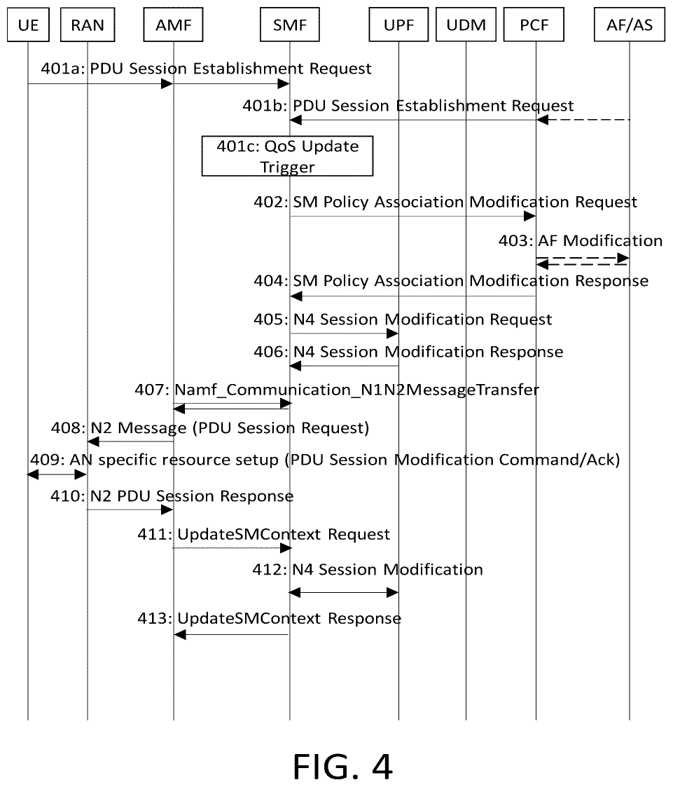

FIG. 4 shows a schematic diagram of a PDU Session Modification procedure according to an embodiment of the present disclosure. The PDU Session Modification procedure may be triggered by the UE, the PCF or the SMF. Other network function (e.g., the UDM, the RAN, or the AMF) may also trigger the PDU Session Modification procedure in certain scenarios. The PDU Session Modification procedure shown in FIG. 4 comprises the following steps.

Step 401: The PDU Session Modification procedure may be triggered by events described in steps 401a, 401b and 401c.

Step 401a: The UE initiates the PDU Session Modification procedure by the transmission of an NAS message (N1 SM container (PDU Session Modification Request), PDU Session ID). The NAS message is forwarded by the RAN to the AMF. The AMF invokes Nsmf_PDUSession_UpdateSMContext (SM Context ID, N1 SM container (PDU Session Modification Request)).

Step 401b: The PCF performs a PCF initiated SM Policy Association Modification procedure to notify SMF about the modification of policies. This may be triggered by a policy decision or upon AF requests, e.g., Application Function influence on traffic routing.

Step 401c: The SMF may decide to modify PDU Session. This procedure also may be triggered based on locally configured policy or triggered from the RAN. It may also be triggered if the UP connection is activated and the SMF has marked that the status of one or more QoS Flows are deleted in the 5GC but not synchronized with the UE yet.

Step 402: The SMF may initiate SM Policy Association Modification procedure towards the PCF, if PDU Session Modification procedure is not triggered by the PCF. The SMF sends Npcf_PolicyAssociation_Update Request to the PCF, to retrieve the updated QoS rules from the PCF.

Step 403: For a specific service, the PCF may interact with the AF to update the AF association. The AF may send determine dynamical traffic authorization to this PDU session.

Step 404: The PCF sends Npcf_PolicyAssociation_Update Response to the SMF, to return the updated PCC Rules for the PDU Session.

Step 405: The SMF sends an N4 Session Modification Request to the UPF to request modification N4 session for this PDU Session, carrying a set of rules for packet detection and QoS enhancement to be installed in the UPF. The rules include Packet Detection Rule (PDR), Forward Action Rule (FAR), QOS Enhancement Rule (QER), Usage Reporting Rule (URR), etc. The SMF maps the updated PCC rules received from the PCF to a set of QoS flows and generates a set of updated PDR/FAR/QER/URR rules accordingly to reflect the updated QoS flows.

The UPF installs these updated rules for this PDU session and uses these rules to filter the uplink/downlink traffic and performs corresponding QoS enhancement to the filtered uplink/downlink traffic.

Step 406: The UPF acknowledges by sending an N4 Session Modification Response.

Step 407: SMF to AMF: Namf_Communication_NIN2MessageTransfer Request (PDU Session ID, N2 SM information (PDU Session ID, QFI(s), QoS Profile(s), N3 CN Tunnel Info), N1 SM container (PDU Session Modification Command)).

Step 408: AMF to RAN: N2 PDU Session Request (N2 SM information, NAS message (PDU Session ID, N1 SM container (PDU Session Modification Command))). The AMF sends the NAS message containing PDU Session ID and PDU Session Modification Command targeted to the UE and the N2 SM information received from the SMF within the N2 PDU Session Request to the RAN.

Step 409: RAN to UE: The RAN may issue AN specific signalling exchange with the UE that is related with the information received from SMF.

Step 410: RAN to AMF: N2 PDU Session Response (PDU Session ID, Cause, N2 SM information (PDU Session ID, AN Tunnel Info, List of accepted/rejected QFI(s))).

Step 411: AMF to SMF: Nsmf_PDUSession_UpdateSMContext Request (N2 SM information).

The AMF forwards the N2 SM information received from RAN to the SMF. If the list of rejected QFI(s) is included in N2 SM information, the SMF shall release the rejected QFI(s) associated QoS profiles.

Step 412: The SMF initiates an N4 Session Modification procedure with the UPF. The SMF provides RAN Tunnel Info to the UPF as well as the corresponding forwarding rules.

Step 413: The SMF sends a Nsmf_PDUSession_UpdateSMContext Response to the AMF.

In an embodiment, the UPF is instructed to detect QUIC traffic and report information associated with the QUIC traffic detection. For example, during the PFCP Session Establishment procedure, the SMF may instruct the UPF to detect the QUIC traffic and report QUIC traffic detection.

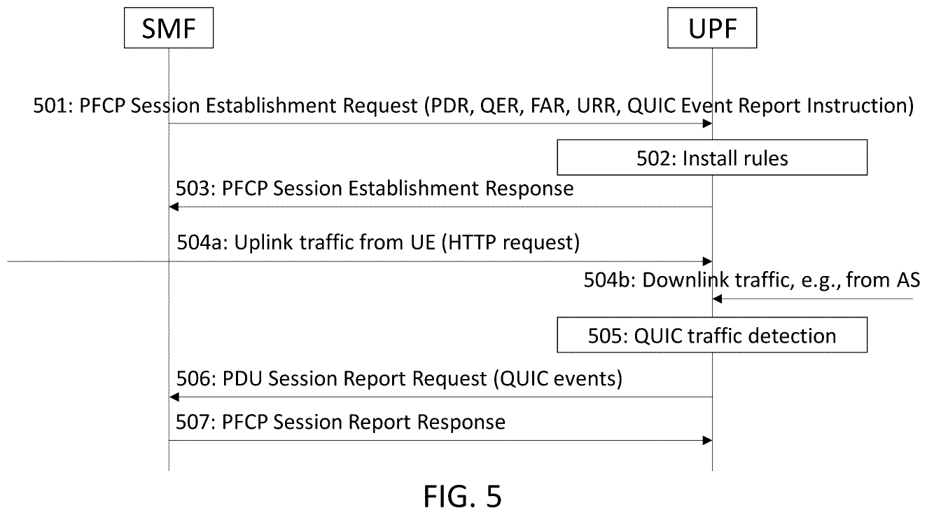

FIG. 5 shows a schematic diagram of the PFCP Session Establishment procedure according to an embodiment of the present disclosure. In FIG. 5 the SMF provides the instruction for the QUIC traffic detection to the UPF. Specifically, the PFCP Session Establishment procedure comprises the following steps:

Step 501: The SMF sends a PFCP Session Establishment Request to a selected UPF, wherein the PFCP Session Establishment Request carries the PDR, QER, FAR, URR.

In this embodiment, the SMF carries a QUIC Traffic Handling Instruction, to request the UPF to perform a special handling on QUIC traffic.

In an embodiment, the QUIC Traffic Handling Instruction may include a QUIC Event Report Instruction configured to instruct the UPF to detect and report certain interested QUIC events. For example, at least one of following QUIC events may be required to be detected and reported:
an event of QUIC traffic detection, which requires the UPF to detect and report the first detection of QUIC traffic transmission;
an event of QUIC connection establishment, which requires the UPF to detect and report the event of QUIC connection establishment;
an event of QUIC connection release, which requires the UPF to detect and report the event of QUIC connection release;
an event of QUIC data block transmission start, which requires the UPF to detect/report the start of a block of QUIC packets transmission; or
an event of QUIC data block transmission stop, which requires the UPF to detect and report the stop of a block of QUIC packets transmission.

In an embodiment, the SMF may only request the UPF to detect a general QUIC event (e.g., the event of QUIC traffic detection). In this embodiment, the UPF detects the QUIC traffic no matter whether the QUIC traffic is related to any special QUIC event. As an alternative or in addition, the SMF may request the UPF to detect one or more special QUIC events, e.g., at least one of the event of QUIC connection establishment/release and the event of QUIC data block transmission start/stop.

In an embodiment, the QUIC Traffic Handling Instruction may include a QUIC Statistics Report Instruction configured to instruct the UPF to analyze the QUIC traffic transmission, collect the QUIC traffic statistics and report results associated with the QUIC traffic statistics. For instance, at least one of the following QUIC traffic statistics may be analyzed/collected/reported:
an average delay of QUIC data transmission, maximum delay of QUIC traffic transmission, minimum delay of QUIC data transmission;
an average size of QUIC data block,
the maximum size of QUIC data block,
minimum size of QUIC data block; or
an average transmission interval between (every two consecutive) QUIC data blocks;

Step 502: On receiving the PFCP Session Establishment request from the SMF, the UPF installs the received rules (i.e. PDR/QER/FAR/URR) for this PFCP session.

In an embodiment of the QUIC Event Report Instruction being provided, the UPF stores the QUIC Event Report Instruction and performs detections on the indicated QUIC events.

In an embodiment of the QUIC Statistics Report Instruction being provided, the UPF stores the QUIC Statistics Report Instruction and perform QUIC traffic analysis and collect QUIC traffic statistics.

Step 503: The UPF sends a PFCP Session Establishment Response message to the SMF.

Step 504a/504b: Later on, the uplink/downlink traffic arrives at the UPF.

Step 505: If the QUIC Traffic Handling Instruction is provided by the SMF, the UPF performs QUIC events detection and/or performs QUIC traffic analysis.

Note that either the QUIC events detection or the QUIC traffic characteristics analysis requires that the UPF is able to detect QUIC traffic and collects QUIC traffic parameters.

Generally, an HTTP server implementing the QUIC protocol listens to the QUIC traffic on certain special UDP ports (e.g., port 443 reserved for TLS, or port 80/8080 reserved for HTTP). Thus, the UPF may be instructed by the SMF or through local rules of the UPF to detect the QUIC traffic by checking and filtering the QUIC traffic from uplink UDP traffic based on pre-configured UDP ports (e.g., port 443).

Once the QUIC traffic are detected, the UPF collects QUIC traffic parameters from the UDP packet header and/or the QUIC packet header. For example, the UPF may detect at least one of the following QUIC traffic parameters:
Transport protocol type, indicating the transport protocol is QUIC over UDP;
UE IP address and UDP port, used by the UE to send or receive QUIC traffic;
Remote Server IP address and UDP port, used by the remote server to send or receive QUIC traffic;
QUIC version, extracted from QUIC packet header, indicating the QUIC protocol version;
QUIC Packet Number, extracted from QUIC packet header, indicating the Packet Number of QUIC packets;
QUIC Connection ID(s), extracted from QUIC packet header, identifying one QUCI connection between two endpoints (e.g. the UE and the remote server). The QUIC Connection ID used by the UE for sending uplink QUIC traffic is different from the QUIC Connection ID used by the remote server for sending downlink QUIC traffic. The UPF should be able to recognize the different QUIC Connection IDs.

In addition, if reporting certain QUIC event is required, the UPF shall further check if the indicated QUIC event happens.

Step 506: The UPF sends a PFCP Session Report request to the SMF, carrying QUIC traffic report.

In an embodiment, at least one of the following information items shall be included in the QUIC traffic report:
the QUIC Traffic Parameters IE, which carry a combination of following QUIC traffic parameters: QUIC protocol indication, UE IP address and port(s), remote server IP address and port(s), QUIC Connection ID(s), QUIC version, QUIC Packet Number;
the QUIC Events IE, which indicates at least one type of QUIC events;
the QUIC Traffic Characteristics IE, which carry a combination of the following QUIC traffic characteristics: average delay of QUIC traffic transmission, maximum delay of QUIC traffic transmission, minimum delay of QUIC traffic transmission, average size of QUIC data block, maximum size of QUIC data block, minimum size of QUIC data block, average interval of QUIC traffic transmission. In addition, an analytic duration may be present to indicate the period in which the QUIC traffic characteristics are collected.

Step 507: The SMF sends a PFCP Session Report response to the UPF. The SMF may use the reported QUIC events and/or QUIC traffic characteristics to request the PCF to update the PCC rules accordingly.

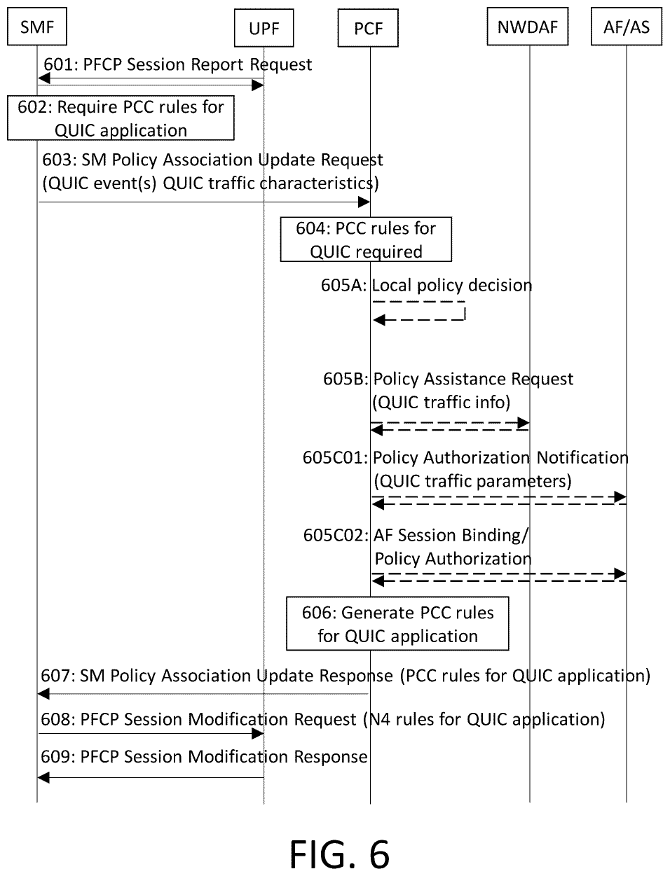

In some embodiments, the SMF may request the PCF to provide PCC rules for QUIC application, e.g. when it receives PFCP session report on QUIC traffic detection. FIG. 6 shows a schematic diagram of a PFCP Session Establishment procedure according to an embodiment of the present disclosure. In FIG. 6, the SMF provides instruction for the QUIC traffic detection to the UPF during the FCP Session Establishment procedure.

Step 601: The SMF receives PFCP Session Report from the UPF, carrying the QUIC traffic report. For example, the SMF may receive the PFCP Session Report as described in the procedure of FIG. 5.

Step 602: The SMF determines that PCC rules for QUIC application are required. If dynamic PCC is implemented, the SMF needs to retrieve PCC rules for QUIC application from the PCF; otherwise, the SMF may use local configured rules to generate PCC rules for the QUIC application.

Step 603: If dynamic PCC is implemented, the SMF sends SM Policy Association Update request to the PCF, carrying the QUIC Traffic Information.

In an embodiment, the QUIC Traffic Information IE includes at least one of the following information items:
the QUIC Traffic Parameters IE, which carry a combination of following QUIC traffic parameters: QUIC protocol indication, UE IP address and port(s), remote server IP address and port(s), QUIC Connection ID(s), QUIC version, QUIC Packet Number;
the QUIC Events IE, which indicates at least one type of QUIC events;
the QUIC Traffic Characteristics IE, which carry a combination of the following QUIC traffic characteristics: average delay of QUIC traffic transmission, maximum delay of QUIC traffic transmission, minimum delay of QUIC traffic transmission, average size of QUIC data block, maximum size of QUIC data block, minimum size of QUIC data block, average interval of QUIC traffic transmission. In addition, an analytic duration may be present to indicate the period in which the QUIC traffic characteristics are collected.

Step 604: On receiving the SM Policy Association Update from the SMF, the PCF determines that generating PCC rules for QUIC application is needed to be based on the received QUIC traffic information.

In an embodiment, if the PCF is configured with local rules for QUIC application (e.g. rules to recognize various QUIC applications, policy rules for those QUIC applications, etc.), or is able to retrieves such rules from out storage (e.g. UDR), the PCF performs step 605A to generate policy rules.

In an embodiment, if the PCF is configured to retrieve policy assistance information from the NWDAF, the PCF performs step 605B to get policy assistance information.

In an embodiment, if the PCF is configured to contact corresponding AF implemented to handle QUIC applications, the PCF performs steps 605C01 and 605C02 to get policy information from the AF.

Step 605A: The PCF recognizes the QUIC application based on SMF provided QUIC Traffic Information, and determines policy rules for that QUIC application, based on local configured rules or rules retrieved from out storage (e.g. UDR).

Step 605B: The PCF sends a Policy Assistance Request to the NWDAF, carrying the QUIC Traffic Information. The NWDAF sends a Policy Assistance Response to the PCF, carrying the Policy Assistance Info.

In an embodiment, the Policy Assistance Info returned by the NWDAF may contain/comprise at least one of the following information: application service type, application identifier, applicable QoS policy (e.g. AMBR, GBR, highest AMBR, lowest AMBR, highest GBR, lowest GBR, etc.). Such information assists the PCF to correctly generate policy rules for the QUIC traffic.

In an embodiment, the NWDAF may further associate the QoS policy to certain QUIC Packet Number range. For example: for a Packet Number within QUIC Packet Number Range #1, AMBR #1 and GBR #1 is applied, while for another Packet Number within QUIC Packet Number Range #2, AMBR #2 and GBR #2 is applied.

On receiving the QUIC Traffic Information from the PCF, the NWDAF uses its knowledge to deduce the service type, application identifier, and applicable QoS policy for the reported QUIC traffic. The NWDAF may collect various QUIC events and QUIC statistics from the network, and may use AI methods to deduce the related information for QUIC services/applications.

Step 605C01: The PCF sends a Policy Authorization Notification to the AF, carrying the QUIC Traffic Information. The AF may verify the QUIC traffic information (e.g. QUIC traffic parameters) and determines to initiate AF session binding to the PCF.

Step 605C02. The AF initiates an AF Session Binding procedure to the PCF and provides application service information for QUIC to the PCF.

In an embodiment, the application service information for QUIC may contain/comprise the combination of at least one of the following items: Application Service Type (identifying the service of the QUIC application), Application Identifier (identifying the QUIC application), UE Identifier (e.g. SUPI or GPSI), UE IP address and ports(s), remote service IP address and ports, QUIC Connection ID(s), or applicable QoS policy (e.g., AMBR, GBR, highest AMBR, lowest AMBR, highest GBR, lowest GBR, etc.).

Step 606: The PCF generates PCC rules for QUIC application by using the retrieved information in steps 605A, 605B or 605C01 and 605C02.

In an embodiment of step 605A being performed, the PCF uses the QUIC application information derived by itself through local configured rules or out storage rules, to generate PCC rules for the reported QUIC application.

In an embodiment of step 5B being performed, the PCF uses the policy assistance information retrieved from the NWDAF, to generate PCC rules for the reported QUIC application.

In an embodiment of steps 605C01 and 605C02 being performed, the PCF uses the application service information retrieved from the AF to generate PCC rules for the reported QUIC application.

In an embodiment, the generated PCC rules may contain/comprise at least one of the following information:
1) the QUIC application information, it further includes at least one of: application identifier, application service type, UE identifier;
2) the QUIC connection information, it further includes at least one of: QUIC Connection ID(s), UE IP address and UDP port(s), remote server IP address and UDP port(s); or
3) the QoS flow parameters for QUIC traffic, it further includes at least one of: QoS Flow Identifier (QFI), Allocation and Retention Priority (ARP), Average Maximum Bit Rate (AMBR), Guaranteed Bit Rate (GBR), etc. The QoS flow parameters may further include one of the following: highest AMBR, lowest AMBR, highest GBR, and lowest GBR. Or, the QoS flow parameters may further include a list of QUIC Packet Number ranges and the corresponding AMBR, GBR associated to each QUIC Packet Number range.

Step 607: The PCF sends an SM Policy Association Update response to the SMF, carrying the PCC rules for QUIC application.

Step 608: On receiving the PCC rules for QUIC application, the SMF generates the corresponding PFCP rules (i.e. PDR/QER/FAR/URR rules etc.) for the QUIC application and sends a PFCP Session Modification Request to the UPF, carrying the updated PFCP rules. Not that the PFCP rules is also named as N4 rules on the N4 interface.

In an embodiment, at least one PDR rule for the QUIC traffic detection is created.

One or more QER/FAR/URR rules for QUIC traffic are created and linked to the PDR rule(s) for QUIC traffic detection mentioned above.

In an embodiment, at least of one the following information may be carried in the N4 rules (e.g. in the PDR) to instruct the UPF to detect the specific QUIC traffic:
QUIC Traffic Detection indication, to instruct the UPF to detect QUIC traffic.
UE IP address and UDP port(s), to instruct the UPF to detect the QUIC traffic from/to that UE address;
Remote Server IP address and port(s), to instruct the UPF to detect QUIC traffic from/to that remote server address;
QUIC Connection ID(s), to instruct the UPF to detect the QUIC traffic over the indicated QUIC connection;

Step 609: The UPF receives the PFCP Session Modification Request and updates the received N4 rules (e.g. PDR/QER/FAR/URR rules, etc.) to its storage.

Step 610: Based on the updated N4 rules, the UPF starts to detect QUIC traffic for the specific QUIC application and performs required actions (e.g., gate control, QoS enforcement, forwarding, usage reporting, etc.) to the detected QUIC traffic.

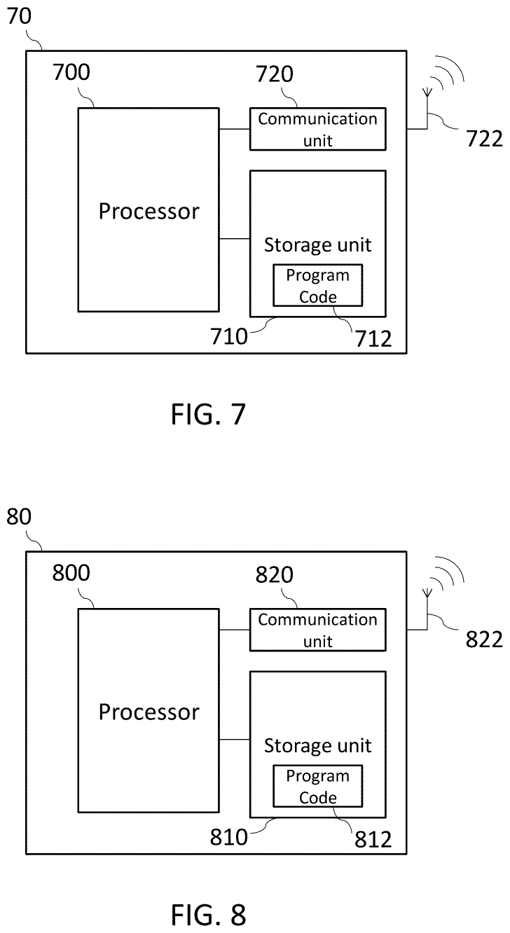

FIG. 7 relates to a schematic diagram of a wireless terminal 70 according to an embodiment of the present disclosure. The wireless terminal 70 may be a user equipment (UE), a mobile phone, a laptop, a tablet computer, an electronic book or a portable computer system and is not limited herein. The wireless terminal 70 may include a processor 700 such as a microprocessor or Application Specific Integrated Circuit (ASIC), a storage unit 710 and a communication unit 720. The storage unit 710 may be any data storage device that stores a program code 712, which is accessed and executed by the processor 700. Embodiments of the storage unit 710 include but are not limited to a subscriber identity module (SIM), read-only memory (ROM), flash memory, random-access memory (RAM), hard-disk, and optical data storage device. The communication unit 720 may a transceiver and is used to transmit and receive signals (e.g. messages or packets) according to processing results of the processor 700. In an embodiment, the communication unit 720 transmits and receives the signals via at least one antenna 722 shown in FIG. 7.

In an embodiment, the storage unit 710 and the program code 712 may be omitted and the processor 700 may include a storage unit with stored program code.

The processor 700 may implement any one of the steps in exemplified embodiments on the wireless terminal 70, e.g., by executing the program code 712.

The communication unit 720 may be a transceiver. The communication unit 720 may as an alternative or in addition be combining a transmitting unit and a receiving unit configured to transmit and to receive, respectively, signals to and from a wireless network node (e.g. a base station).

FIG. 8 relates to a schematic diagram of a wireless network node 80 according to an embodiment of the present disclosure. The wireless network node 80 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 80 may comprise (perform) at least one network function such as an access and mobility management function (AMF), a session management function (SMF), a user place function (UPF), a policy control function (PCF), an application function (AF), etc. The wireless network node 80 may include a processor 800 such as a microprocessor or ASIC, a storage unit 810 and a communication unit 820. The storage unit 810 may be any data storage device that stores a program code 812, which is accessed and executed by the processor 800. Examples of the storage unit 810 include but are not limited to a SIM, ROM, flash memory, RAM, hard-disk, and optical data storage device. The communication unit 820 may be a transceiver and is used to transmit and receive signals (e.g. messages or packets) according to processing results of the processor 800. In an example, the communication unit 820 transmits and receives the signals via at least one antenna 822 shown in FIG. 8.

In an embodiment, the storage unit 810 and the program code 812 may be omitted. The processor 800 may include a storage unit with stored program code.

The processor 800 may implement any steps described in exemplified embodiments on the wireless network node 80, e.g., via executing the program code 812.

The communication unit 820 may be a transceiver. The communication unit 820 may as an alternative or in addition be combining a transmitting unit and a receiving unit configured to transmit and to receive, respectively, signals to and from a wireless terminal (e.g. a user equipment or another wireless network node).

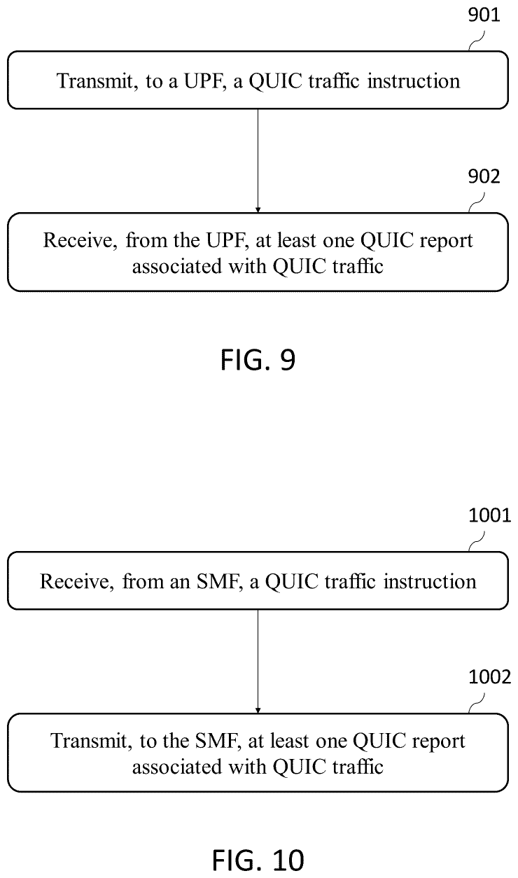

FIG. 9 shows a flowchart of a method according to an embodiment of the present disclosure. The method shown in FIG. 9 may be used in an SMF (e.g., a session management node, a wireless device comprising the SMF or a wireless device comprising performing at least part of functionalities of the SMF) and comprises the following steps:

Step 901: Transmit, to a UPF, a QUIC traffic instruction.

Step 902: Receive, from the UPF, at least one QUIC report associated with QUIC traffic.

In FIG. 9, the SMF transmits a QUIC traffic instruction to UPF, e.g., to instruct the UPF to detect and/or collect information of QUIC traffic. In response to the QUIC traffic instruction, at least one QUIC report associated with the QUIC traffic is transmitted from the UPF to the SMF.

In an embodiment, the QUIC traffic instruction comprises at least one of a QUIC event report instruction indicating at least one event associated with (generating/reporting) the at least one QUIC report or a QUIC statistic report instruction indicating at least one statistic included in each QUIC report.

In an embodiment, the at least one event associated with the at least one QUIC report comprises at least one of: an event associated with a QUIC traffic detection, an event associated with a QUIC connection establishment, an event associated with a QUIC connection release, an event associated with a start of a QUIC data block transmission, or an event associated with an end of a QUIC data block transmission. More details of each event may be referred to the embodiments shown in FIGS. 5 and 6.

In an embodiment, the at least one statistic included in each QUIC report comprises at least one of: an average delay of QUIC traffic transmissions, a maximum delay of QUIC traffic transmissions, a minimum delay of QUIC traffic transmissions, an average size of QUIC data blocks, a maximum size of QUIC data blocks, a minimum size of QUIC data blocks, an average interval between every two consecutive QUIC traffic transmissions, or an analytic duration indicating a period in which QUIC traffic characteristics used for determining each QUIC report are collected.

In an embodiment, each QUIC report comprises at least one of: at least one QUIC traffic parameter of the QUIC traffic, the at least one QUIC report event associated with the QUIC report, or the at least one statistic of the QUIC traffic associated with the QUIC report.

In an embodiment, at least one QUIC traffic parameter comprises at least one of: a QUIC protocol indication associated with the QUIC traffic, an IP address of a wireless terminal (e.g. UE) associated with the QUIC traffic and a UDP port associated with the wireless terminal, an IP address of a remote server associated with the QUIC traffic and a UDP port associated with the remote server, at least one QUIC connection identifier of the QUIC traffic, a QUIC version of the QUIC traffic, or a packet number of the QUIC traffic.

Note that, in the present disclosure, at least one of A, B and/or C may refer to at least one A and/or at least one B and/or at least one C, wherein A/B/C refers to a parameter, an element, a statistics, . . . , etc.

FIG. 10 shows a flowchart of a method according to an embodiment of the present disclosure. The method shown in FIG. 10 may be used in a UPF (e.g., a user plane node, a wireless device comprising the UPF or a wireless device comprising performing at least part of functionalities of the UPF) and comprises the following steps:

Step 1001: Receive, from an SMF, a QUIC traffic instruction.

Step 1002: Transmit, to the SMF, at least one QUIC report associated with QUIC traffic.

In this embodiment, the UPF receives a QUIC traffic instruction form an SMF. Based on the QUIC traffic instruction, the UPF starts detecting QUIC traffic and collecting information associated with the detected QUIC traffic. The UPF transmits at least one QUIC report associated with QUIC traffic.

In an embodiment, the QUIC traffic instruction comprises at least one of a QUIC event report instruction indicating at least one event associated with (generating/reporting) the at least one QUIC report or a QUIC statistic report instruction indicating at least one statistic included in each QUIC report.

In an embodiment, the at least one event associated with the at least one QUIC report comprises at least one of: an event associated with a QUIC traffic detection, an event associated with a QUIC connection establishment, an event associated with a QUIC connection release, an event associated with a start of a QUIC data block transmission, or an event associated with an end of a QUIC data block transmission. More details of each event may be referred to the embodiments shown in FIGS. 5 and 6.

In an embodiment, the at least one statistic included in each QUIC report comprises at least one of: an average delay of QUIC traffic transmissions, a maximum delay of QUIC traffic transmissions, a minimum delay of QUIC traffic transmissions, an average size of QUIC data blocks, a maximum size of QUIC data blocks, a minimum size of QUIC data blocks, an average interval between every two consecutive QUIC traffic transmissions, or an analytic duration indicating a period in which QUIC traffic characteristics used for determining each QUIC report are collected.

In an embodiment, each QUIC report comprises at least one of: at least one QUIC traffic parameter of the QUIC traffic, the at least one QUIC report event associated with the QUIC report, or the at least one statistic of the QUIC traffic associated with the QUIC report.

In an embodiment, at least one QUIC traffic parameter comprises at least one of: a QUIC protocol indication associated with the QUIC traffic, an IP address of a wireless terminal (e.g. UE) associated with the QUIC traffic and a UDP port associated with the wireless terminal, an IP address of a remote server associated with the QUIC traffic and a UDP port associated with the remote server, at least one QUIC connection identifier of the QUIC traffic, a QUIC version of the QUIC traffic, or a packet number of the QUIC traffic.

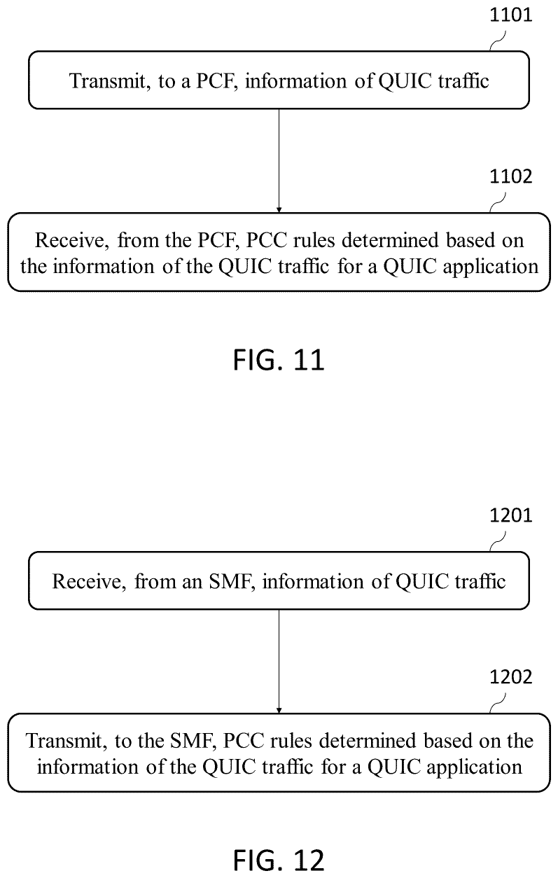

FIG. 11 shows a flowchart of a method according to an embodiment of the present disclosure. The method shown in FIG. 11 may be used in an SMF (e.g., a session management node, a wireless device comprising the SMF or a wireless device performing at least part of functionalities of the SMF) and comprises the following steps:

Step 1101: Transmit, to a PCF, information of QUIC traffic.

Step 1102: Receive, from the PCF, PCC rules determined based on the information of the QUIC traffic for a QUIC application.

In FIG. 11, the SMF transmits information of QUIC traffic to a PCF. For example, the SMF may receive/request the information of the QUIC traffic from a UPF by performing the method in FIG. 9. Based on the information of the QUIC traffic, the PCF may determine/optimize/modify/adjust/add PCC rules for a QUIC application and transmit the PCC rules to the SMF. By adopting the PCC rules, the SMF therefore can handle the QUIC traffic of the QUIC application more efficiently.

In an embodiment, the QUIC information comprises at least one event associated with the information of the QUIC traffic and/or statistics of the QUIC traffic.

In an embodiment, the at least one event associated with the at least one QUIC report comprises at least one of: an event associated with a QUIC traffic detection, an event associated with a QUIC connection establishment, an event associated with a QUIC connection release, an event associated with a start of a QUIC data block transmission, or an event associated with an end of a QUIC data block transmission. More details of each event may be referred to the embodiments shown in FIGS. 5 and 6.

In an embodiment, the at least one statistic included in each QUIC report comprises at least one of: an average delay of QUIC traffic transmissions, a maximum delay of QUIC traffic transmissions, a minimum delay of QUIC traffic transmissions, an average size of QUIC data blocks, a maximum size of QUIC data blocks, a minimum size of QUIC data blocks, an average interval between every two consecutive QUIC traffic transmissions, or an analytic duration indicating a period in which QUIC traffic characteristics used for determining each QUIC report are collected.

In an embodiment, the information of the QUIC traffic further comprises at least one QUIC traffic parameter, which comprises at least one of: a QUIC protocol indication associated with the QUIC traffic, an IP address of a wireless terminal (e.g. UE) associated with the QUIC traffic and a UDP port associated with the wireless terminal, an IP address of a remote server associated with the QUIC traffic and a UDP port associated with the remote server, at least one QUIC connection identifier of the QUIC traffic, a QUIC version of the QUIC traffic, or a packet number of the QUIC traffic.

In an embodiment, the PCC rules comprise at least one of: QUIC application information, QUIC connection information, or at least one QUIC flow parameter.

In an embodiment, wherein the QUIC application information comprises at least one of: an application identifier of the QUIC application, an application service type of the QUIC application, or an identifier of a wireless terminal associated with the QUIC application.

In an embodiment, the QUIC connection information comprises at least one of: at least one QUIC Connection identifier of the QUIC application, an IP address of a wireless terminal associated with the QUIC application and a UDP port associated with the wireless terminal, or an IP address of a remote server associated with the QUIC application and a UDP port associated with the remote server.

In an embodiment, the at least one QUIC flow parameters comprises at least one of: a QoS Flow Identifier, an Allocation and Retention Priority, an AMBR or a GBR.

In an embodiment, the at least one QUIC flow parameters comprises at least one of: a highest AMBR, a lowest AMBR, a highest GBR, or a lowest GBR.

In an embodiment, the at least one QUIC flow parameters comprises at least one of: a list of QUIC Packet Number ranges and AMBRs corresponding to the QUIC Packet Number ranges, or a list of QUIC Packet Number ranges and GBRs corresponding to the QUIC Packet Number ranges.

FIG. 12 shows a flowchart of a method according to an embodiment of the present disclosure. The method shown in FIG. 12 may be used in a PCF (e.g. a policy control node, a wireless device comprising the PCF or a wireless device performing at least part of functionalities of the PCF) and comprises the following steps:

Step 1201: Receive, from an SMF, information of QUIC traffic.

Step 1202: Transmit, to the SMF, PCC rules determined based on the information of the QUIC traffic for a QUIC application.

In FIG. 12, the PCF receives information of QUIC traffic from an SMF. Based on the received information, the PCF may determine/optimize/modify/adjust/add PCC rules for a QUIC application and transmit the PCC rules to the SMF, e.g., to allow the SMF to efficiently process the QUIC traffic for the QUIC application.

In an embodiment, the QUIC information comprises at least one event associated with the information of the QUIC traffic and/or statistics of the QUIC traffic.

In an embodiment, the at least one event associated with the at least one QUIC report comprises at least one of: an event associated with a QUIC traffic detection, an event associated with a QUIC connection establishment, an event associated with a QUIC connection release, an event associated with a start of a QUIC data block transmission, or an event associated with an end of a QUIC data block transmission. More details of each event may be referred to the embodiments shown in FIGS. 5 and 6.

In an embodiment, the at least one statistic included in each QUIC report comprises at least one of: an average delay of QUIC traffic transmissions, a maximum delay of QUIC traffic transmissions, a minimum delay of QUIC traffic transmissions, an average size of QUIC data blocks, a maximum size of QUIC data blocks, a minimum size of QUIC data blocks, an average interval between every two consecutive QUIC traffic transmissions, or an analytic duration indicating a period in which QUIC traffic characteristics used for determining each QUIC report are collected.

In an embodiment, the information of the QUIC traffic further comprises at least one QUIC traffic parameter, which comprises at least one of: a QUIC protocol indication associated with the QUIC traffic, an IP address of a wireless terminal (e.g. UE) associated with the QUIC traffic and a UDP port associated with the wireless terminal, an IP address of a remote server associated with the QUIC traffic and a UDP port associated with the remote server, at least one QUIC connection identifier of the QUIC traffic, a QUIC version of the QUIC traffic, or a packet number of the QUIC traffic.

In an embodiment, the PCC rules comprise at least one of: QUIC application information, QUIC connection information, or at least one QUIC flow parameter.

In an embodiment, wherein the QUIC application information comprises at least one of: an application identifier of the QUIC application, an application service type of the QUIC application, or an identifier of a wireless terminal associated with the QUIC application.

In an embodiment, the QUIC connection information comprises at least one of: at least one QUIC Connection identifier of the QUIC application, an IP address of a wireless terminal associated with the QUIC application and a UDP port associated with the wireless terminal, or an IP address of a remote server associated with the QUIC application and a UDP port associated with the remote server.

In an embodiment, the at least one QUIC flow parameters comprises at least one of: a QoS Flow Identifier, an Allocation and Retention Priority, an AMBR or a GBR.

In an embodiment, the at least one QUIC flow parameters comprises at least one of: a highest AMBR, a lowest AMBR, a highest GBR, or a lowest GBR.

In an embodiment, the at least one QUIC flow parameters comprises at least one of: a list of QUIC Packet Number ranges and AMBRs corresponding to the QUIC Packet Number ranges, or a list of QUIC Packet Number ranges and GBRs corresponding to the QUIC Packet Number ranges.

In an embodiment, the PCF further transmits a QUIC assistance request including the information of the QUIC traffic to an NWDAF. In response to the QUIC assistance request, the NWDAF transmits QUIC assistance information to the PCF. The PCF determines the PCC rules further based on the QUIC assistance information.

In an embodiment, the QUIC assistance information comprises at least one of: an application service type associated with the QUIC traffic, an application identifier associated with the QUIC traffic, at least one QoS policy for the QUIC traffic, or at least one QUIC packet number range corresponding to the at least one QoS policy.

In an embodiment, the PCF may transmit a policy authorization notification including the information of the QUIC traffic to an AF and receive application service information associated with the QUIC traffic from the AF. Based on the application service information, the PCF determines the PCC rules.

In an embodiment, the application service information comprising at least one of: an application service type associated with the QUIC traffic, an application identifier associated with the QUIC traffic, an identifier of a wireless terminal associated with the QUIC traffic, an IP address of a wireless terminal associated with the QUIC traffic and a UDP port associated with the wireless terminal, an IP address of a remote server associated with the QUIC traffic and a UDP port associated with the remote server, or at least one QoS policy for the QUIC traffic.

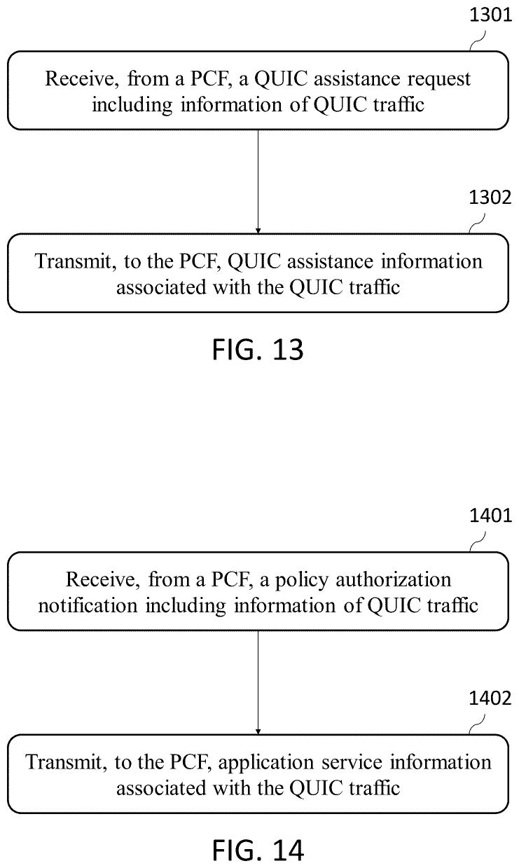

FIG. 13 shows a flowchart of a method according to an embodiment of the present disclosure. The method shown in FIG. 13 may be used in an NWDAF (e.g., a network data analysis node, a wireless device comprising the NWDAF or a wireless device performing at least part of functionalities of the NWDAF) and comprises the following steps:

Step 1301: Receive, from a PCF, a QUIC assistance request including information of QUIC traffic.

Step 1302: Transmit, to the PCF, QUIC assistance information associated with the QUIC traffic.

In FIG. 13, the NWDAF receives a QUIC assistance request including information of QUIC traffic from a PCF. The NWDAF analyzes the information of QUIC traffic and accordingly generates QUIC assistance information which can be used to determine PCC rules. The generated QUIC assistance information is transmitted to the PCF from the NWDAF.

In an embodiment, the QUIC information comprises at least one event associated with the information of the QUIC traffic and/or statistics of the QUIC traffic.

In an embodiment, the at least one event associated with the at least one QUIC report comprises at least one of: an event associated with a QUIC traffic detection, an event associated with a QUIC connection establishment, an event associated with a QUIC connection release, an event associated with a start of a QUIC data block transmission, or an event associated with an end of a QUIC data block transmission. More details of each event may be referred to the embodiments shown in FIGS. 5 and 6.

In an embodiment, the at least one statistic included in each QUIC report comprises at least one of: an average delay of QUIC traffic transmissions, a maximum delay of QUIC traffic transmissions, a minimum delay of QUIC traffic transmissions, an average size of QUIC data blocks, a maximum size of QUIC data blocks, a minimum size of QUIC data blocks, an average interval between every two consecutive QUIC traffic transmissions, or an analytic duration indicating a period in which QUIC traffic characteristics used for determining each QUIC report are collected.

In an embodiment, the information of the QUIC traffic further comprises at least one QUIC traffic parameter, which comprises at least one of: a QUIC protocol indication associated with the QUIC traffic, an IP address of a wireless terminal (e.g. UE) associated with the QUIC traffic and a UDP port associated with the wireless terminal, an IP address of a remote server associated with the QUIC traffic and a UDP port associated with the remote server, at least one QUIC connection identifier of the QUIC traffic, a QUIC version of the QUIC traffic, or a packet number of the QUIC traffic.

In an embodiment, the QUIC assistance information comprises at least one of: an application service type associated with the QUIC traffic, an application identifier associated with the QUIC traffic, at least one QoS policy for the QUIC traffic, or at least one QUIC packet number range corresponding to the at least one QoS policy.

FIG. 14 shows a flowchart of a method according to an embodiment of the present disclosure. The method shown in FIG. 14 may be used in an AF (e.g., an application node, a wireless device comprising the AF or a wireless device performing at least part of functionalities of the AF) and comprises the following steps:

Step 1401: Receive, from a PCF, a policy authorization notification including information of QUIC traffic.

Step 1402: Transmit, to the PCF, application service information associated with the QUIC traffic.

In this embodiment, the AF receives a policy authorization notification including information of QUIC traffic from a PCF. Based on the information of the QUIC traffic, the AF generates and transmit application service information associated with the QUIC traffic to the PCF, e.g., to help the PCF to determine corresponding PCC rules.

In an embodiment, the QUIC information comprises at least one event associated with the information of the QUIC traffic and/or statistics of the QUIC traffic.

In an embodiment, the at least one event associated with the at least one QUIC report comprises at least one of: an event associated with a QUIC traffic detection, an event associated with a QUIC connection establishment, an event associated with a QUIC connection release, an event associated with a start of a QUIC data block transmission, or an event associated with an end of a QUIC data block transmission. More details of each event may be referred to the embodiments shown in FIGS. 5 and 6.

In an embodiment, the at least one statistic included in each QUIC report comprises at least one of: an average delay of QUIC traffic transmissions, a maximum delay of QUIC traffic transmissions, a minimum delay of QUIC traffic transmissions, an average size of QUIC data blocks, a maximum size of QUIC data blocks, a minimum size of QUIC data blocks, an average interval between every two consecutive QUIC traffic transmissions, or an analytic duration indicating a period in which QUIC traffic characteristics used for determining each QUIC report are collected.

In an embodiment, the information of the QUIC traffic further comprises at least one QUIC traffic parameter, which comprises at least one of: a QUIC protocol indication associated with the QUIC traffic, an IP address of a wireless terminal (e.g. UE) associated with the QUIC traffic and a UDP port associated with the wireless terminal, an IP address of a remote server associated with the QUIC traffic and a UDP port associated with the remote server, at least one QUIC connection identifier of the QUIC traffic, a QUIC version of the QUIC traffic, or a packet number of the QUIC traffic.

In an embodiment, the application service information comprising at least one of: an application service type associated with the QUIC traffic, an application identifier associated with the QUIC traffic, an identifier of a wireless terminal associated with the QUIC traffic, an IP address of a wireless terminal associated with the QUIC traffic and a UDP port associated with the wireless terminal, an IP address of a remote server associated with the QUIC traffic and a UDP port associated with the remote server, or at least one QoS policy for the QUIC traffic.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

What is claimed is:

1. A wireless communication method for use in a session management function, the method comprising:
transmitting, to a user plane function, a Quick User Datagram Protocol Internet Connections (QUIC) traffic instruction, and
receiving, from the user plane function, at least one QUIC report associated with QUIC traffic,
wherein the QUIC traffic instruction comprises at least one of a QUIC event report instruction indicating at least one event associated with the at least one QUIC report or a QUIC statistic report instruction indicating at least one statistic included in each QUIC report.

2. The wireless communication method of claim 1, wherein the at least one event associated with the at least one QUIC report comprises at least one of:
an event associated with a QUIC traffic detection,
an event associated with a QUIC connection establishment,
an event associated with a QUIC connection release,
an event associated with a start of a QUIC data block transmission, or
an event associated with an end of a QUIC data block transmission.

3. The wireless communication method of claim 1, wherein the at least one statistic included in each QUIC report comprises at least one of:
an average delay of QUIC traffic transmissions,
a maximum delay of QUIC traffic transmissions,
a minimum delay of QUIC traffic transmissions,
an average size of QUIC data blocks,
a maximum size of QUIC data blocks,
a minimum size of QUIC data blocks, an average interval between every two consecutive QUIC traffic transmissions, or
an analytic duration indicating a period in which QUIC traffic characteristics used for determining each QUIC report are collected.

4. The wireless communication method of claim 1, wherein each QUIC report comprises at least one of:
at least one QUIC traffic parameter of the QUIC traffic,
the at least one QUIC report event associated with the QUIC report, or
the at least one statistic of the QUIC traffic associated with the QUIC report.

5. The wireless communication method of claim 4, wherein the at least one QUIC traffic parameter comprises at least one of:
a QUIC protocol indication associated with the QUIC traffic,
an internet protocol (IP) address of a wireless terminal associated with the QUIC traffic and a User Datagram Protocol (UDP) port associated with the wireless terminal,
an IP address of a remote server associated with the QUIC traffic and a UDP port associated with the remote server,
at least one QUIC connection identifier of the QUIC traffic,
a QUIC version of the QUIC traffic, or
a packet number of the QUIC traffic.

6. A wireless communication method for use in a user plane function, the method comprising:
receiving, from a session management function, a Quick User Datagram Protocol Internet Connections (QUIC) traffic instruction, and
transmitting, to the session management function, at least one QUIC report associated with QUIC traffic,
wherein the QUIC traffic instruction comprises at least one of a QUIC event report instruction indicating at least one event associated with the at least one QUIC report or a QUIC statistic report instruction indicating at least one statistic included in each QUIC report.

7. The wireless communication method of claim 6, wherein the at least one event associated with the at least one QUIC report comprises at least one of:
an event associated with a QUIC traffic detection,
an event associated with a QUIC connection establishment,
an event associated with a QUIC connection release,
an event associated with a start of a QUIC data block transmission, or
an event associated with an end of a QUIC data block transmission.

8. The wireless communication method of claim 6, wherein the at least one statistic included in each QUIC report comprises at least one of:
an average delay of QUIC traffic transmissions,
a maximum delay of QUIC traffic transmissions,
a minimum delay of QUIC traffic transmissions,
an average size of QUIC data blocks,
a maximum size of QUIC data blocks,
a minimum size of QUIC data blocks, an average interval between every two consecutive QUIC traffic transmissions, or
an analytic duration indicating a period in which QUIC traffic characteristics used for determining each QUIC report are collected.

9. The wireless communication method of claim 6, wherein each QUIC report comprises at least one of:
at least one QUIC traffic parameter of the QUIC traffic,
the at least one QUIC report event associated with the QUIC report, or
the at least one statistic of the QUIC traffic associated with the QUIC report.

10. The wireless communication method of claim 9, wherein the at least one QUIC traffic parameter comprises at least one of:
a QUIC protocol indication associated with the QUIC traffic,
an internet protocol, IP, address of a wireless terminal associated with the QUIC traffic and a User Datagram Protocol (UDP) port associated with the wireless terminal,
an IP address of a remote server associated with the QUIC traffic and a UDP port associated with the remote server,
at least one QUIC connection identifier of the QUIC traffic,
a QUIC version of the QUIC traffic, or
a packet number of the QUIC traffic.

11. A session management node, comprising:
a communication unit, configured to:
transmit, to a user plane function, a Quick User Datagram Protocol Internet Connections (QUIC) traffic instruction, and
receive, from the user plane function, at least one QUIC report associated with QUIC traffic,
wherein the QUIC traffic instruction comprises at least one of a QUIC event report instruction indicating at least one event associated with the at least one QUIC report or a QUIC statistic report instruction indicating at least one statistic included in each QUIC report.

12. The session management node of claim 11, wherein the at least one event associated with the at least one QUIC report comprises at least one of:
an event associated with a QUIC traffic detection,
an event associated with a QUIC connection establishment,
an event associated with a QUIC connection release,
an event associated with a start of a QUIC data block transmission, or
an event associated with an end of a QUIC data block transmission.

13. The session management node of claim 11, wherein the at least one statistic included in each QUIC report comprises at least one of:
an average delay of QUIC traffic transmissions,
a maximum delay of QUIC traffic transmissions,
a minimum delay of QUIC traffic transmissions,
an average size of QUIC data blocks,
a maximum size of QUIC data blocks,
a minimum size of QUIC data blocks, an average interval between every two consecutive QUIC traffic transmissions, or
an analytic duration indicating a period in which QUIC traffic characteristics used for determining each QUIC report are collected.

14. The session management node of claim 11, wherein each QUIC report comprises at least one of:
at least one QUIC traffic parameter of the QUIC traffic,
the at least one QUIC report event associated with the QUIC report, or
the at least one statistic of the QUIC traffic associated with the QUIC report.

15. The session management node of claim 14, wherein the at least one QUIC traffic parameter comprises at least one of:
a QUIC protocol indication associated with the QUIC traffic,
an internet protocol (IP) address of a wireless terminal associated with the QUIC traffic and a User Datagram Protocol (UDP) port associated with the wireless terminal,
an IP address of a remote server associated with the QUIC traffic and a UDP port associated with the remote server,
at least one QUIC connection identifier of the QUIC traffic,
a QUIC version of the QUIC traffic, or
a packet number of the QUIC traffic.
